(19) United States
(12) Patent Application Publication
(10) Pub. No.: US 2026/0109588 A1
(43) Pub. Date: Apr. 23, 2026

(54) KEG SYSTEM

(71) Applicant: Richard Eklund, Las Vegas, NV (US)

(72) Inventor: Richard Eklund, Las Vegas, NV (US)

(21) Appl. No.: 18/923,979

(22) Filed: Oct. 23, 2024

(51) Int. Cl. B67D 1/04; B67D 1/08

(52) U.S. Cl. CPC B67D 1/0431; B67D 1/0884; B67D 2001/0824

(57) ABSTRACT

A keg system for dispensing a liquid has an air compressor device with a pump operably controlled by a controller powered by a power source, the pump functioning to pump air from an air intake to a port that is connected with a pneumatic hose. The air compressor device further has a pressure sensor operably connected with the controller so that the pump is automatically stopped once a sensed pressure reaches a predetermined selected pressure. The keg system further has a keg container having a base and an upwardly extending sidewall that extends upwardly from the base to a top portion to form an interior chamber, the interior chamber being adapted to contain the liquid. A coupler is mounted the top portion of the keg container, and an air inlet port of the coupler is in fluid communication with an air outlet, so that when the pneumatic hose is connected with the inlet port, air pumped from the air compressor device flows into the keg container for pressurizing the interior chamber of the keg container. The system further has a dip tube for dispensing the liquid from the keg container.

### BACKGROUND OF THE INVENTION

### Field of the Invention

This invention relates generally to kegs, and more particularly to a keg system that uses a compressor that maintains a predetermined selected pressure for pressurizing a keg container.

### Description of Related Art

Beverage kegs and keg containers are a well-established product in the field of liquid dispensing, generally provided with standardized equipment, with little variance. Most bars and restaurants use canisters of carbon dioxide for pressurizing the keg, because the carbon dioxide does not flatten the beverage or affect its taste in a negative way. A regulator (gauge) allows the operator to control the amount of pressure within the tanks in real-time, so the operator can switch off pressure once a desired pressure is reached.

Small, portable kegs are often pressurized by regular air, and the pressure is maintained with a hand pump.

The prior art teaches keg systems with pressure mechanisms. However, the prior art does not teach a keg system that uses ordinary air, but is fully automated and does not require a hand pump, and which maintains a predetermined air pressure through the use of a pressure sensor. The keg system further enables the user to customize the pressure, so that different kegs of different beverages, maintained under different conditions, can be maintained at adjustable and customized pressures, and without requiring the added expense of CO2. The present invention fulfills these needs and provides further advantages as described in the following summary.

### SUMMARY OF THE INVENTION

The present invention teaches certain benefits in construction and use which give rise to the objectives described below.

The present invention provides a keg system for dispensing a liquid. The keg system comprises an air compressor device having a pump operably controlled by a controller powered by a power source, the pump functioning to pump air from an air intake to a port that is connected with a pneumatic hose. The air compressor device further comprises a pressure sensor operably connected with the controller so that the pump is automatically stopped once a sensed pressure reaches a predetermined selected pressure. The keg system further has a keg container comprising a base and an upwardly extending sidewall that extends upwardly from the base to a top portion to form an interior chamber, the interior chamber being adapted to contain the liquid. A coupler is mounted the top portion of the keg container, and an air inlet port of the coupler is in fluid communication with an air outlet, so that when the pneumatic hose is connected with the inlet port, air pumped from the air compressor device flows into the keg container for pressurizing the interior chamber of the keg container. The system further has a means for dispensing the liquid from the keg container.

A primary objective of the present invention is to provide a keg system having advantages not taught by the prior art.

Another objective is to provide a keg system that allows a user to select and customize a predetermined pressure for pressurizing a keg container, depending upon the beverage being dispensed, and the conditions (e.g., temperature, etc.) at that location.

A further objective is to provide a keg system including an air compressor device that has a pressure sensor for automatically stopping air pressure when a predetermined selected pressure has been reached.

A further objective is to provide a keg system including an air compressor device of a certain predetermined maximum strength that is low enough to prevent an accidental breach of the keg container.

Other features and advantages of the present invention will become apparent from the following more detailed description, taken in conjunction with the accompanying drawings, which illustrate, by way of example, the principles of the invention.

### BRIEF DESCRIPTION OF THE DRAWINGS

The accompanying drawings illustrate the present invention.

FIG. 1 is a perspective view of a keg system according to one embodiment of the present invention;

FIG. 2 is a sectional view taken along line 2-2 in FIG. 1;

FIG. 3 is sectional view of a second embodiment of a keg container, showing a bladder; and

FIG. 4 is block diagram of an air compressor device of the keg system.

### DETAILED DESCRIPTION OF THE INVENTION

The above-described drawing figures illustrate the invention, a keg system for dispensing liquid.

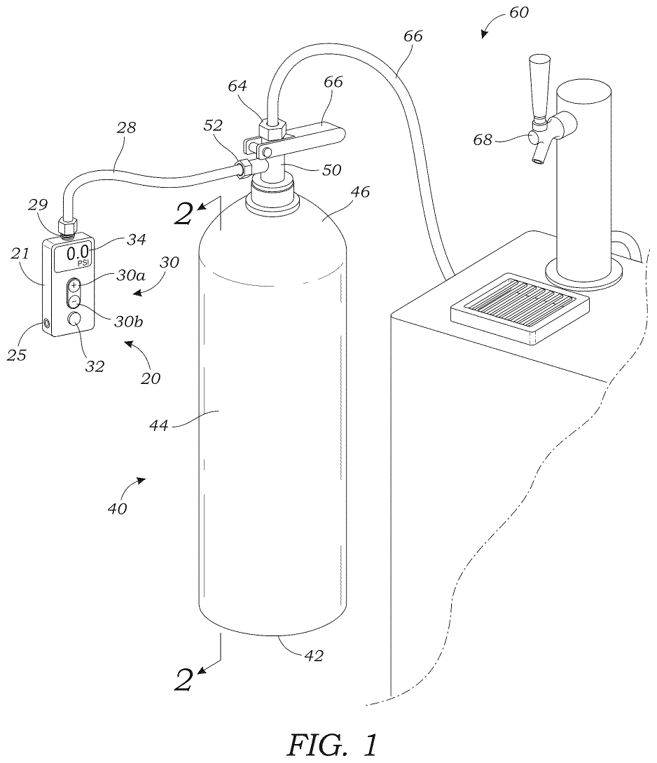

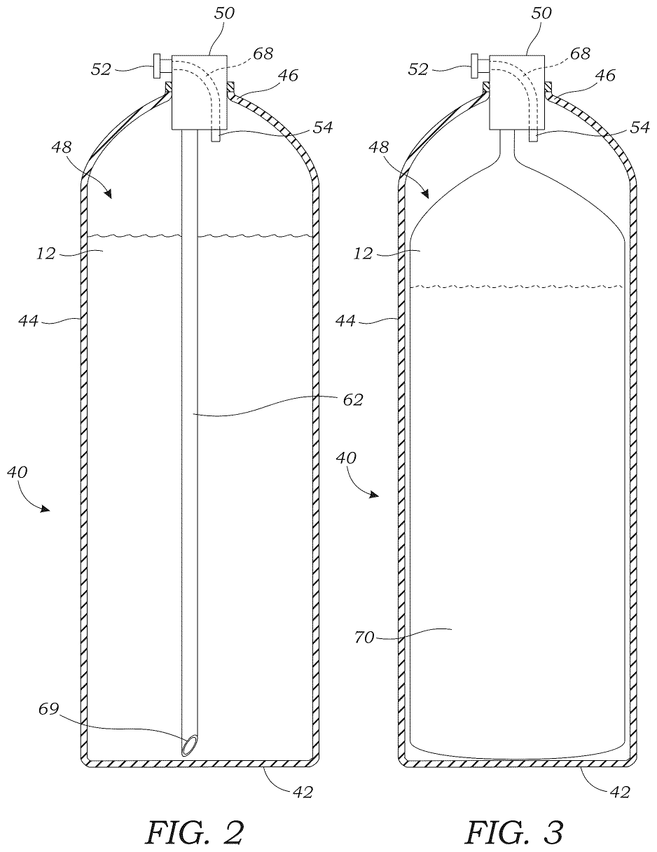

FIG. 1 is a perspective view of a keg system 10 according to one embodiment of the present invention. FIG. 2 is a sectional view taken along line 2-2 in FIG. 1. As shown in FIGS. 1-2, the keg system 10 is adapted to dispense liquid 12 using an air compressor device 20 operably connected to a keg container 40.

In the embodiment of FIG. 1, the air compressor device 20 includes a generally cuboid device housing 21; however, the device housing 21 may be in any suitable shape or size, and may include portions and/or accessories designed to enhance user experience, such as a grip portion, hanging strap, wall mount, etc., which should be considered within the scope of the present invention. As shown in FIG. 1, device housing 21 may include a control mechanism 30 for selecting the maximum pressure that the compressor will pressurize the keg container with compressed air. The control mechanism 30 may be in the form of a plurality of buttons (one or more). In this embodiment, the buttons include a plus button 30a and a minus button 30b. However, any form of control mechanism (e.g., switches, touch screen, microphone for voice commands, wireless controls, etc.) may be used.

A switch 32, which in this embodiment is in the form of another button, may further be included (i.e., for powering on, starting/stopping the pump 22, or similar). Fewer, additional, and/or different buttons may be used, or the buttons 30 may instead be in the form of switches, a touch screen, a mixture of these, or any other similar form of control mechanism known in the art. The device housing 21 may further include a display 34 for displaying a selected pressure, in this embodiment being a digital alphanumerical display, but any form of display may be used, e.g., any form of touch screen, digital or mechanical displays, using any known symbols, as long as it is possible to display a selected pressure.

In use, the user will set the maximum pressure (the max shut off pressure) using the control mechanism 30, with the max pressure being displayed on the display 34. When the compressor is then actuated, it will continue to pump until the pressure sensor determines that this pressure has been reached, at which point the compressor will automatically stop. In one embodiment, the max pressure may be selected between about 5-15 psi, preferably about 7-12 psi

If the pressure within the keg container drops below a certain predetermined threshold minimum pressure, which also may be programmed into the compressor, then the compressor will automatically turn back on and raise the pressure to the correct level. In this embodiment, the minimum pressure is 2-7 psi, more preferably about 4-6 psi, although this will obviously vary depending upon the details of the keg, and the fluid being dispensed, and any range of max/min pressures may be used in alternative embodiments.

In the preferred embodiment, the compressor is particularly designed or selected so that the maximum pressure that may be reached by the compressor is about 40 psi. In any case, it is less than 100 psi, which is significantly less than a typical compressor, which may reach 150 psi or higher, which might rupture some kegs. By providing a compressor of relatively low strength, accidental rupture of the keg is effectively prevented.

As illustrated in FIGS. 1-2, the keg container 40 is of standard construction, and comprises a base 42 and an upwardly extending sidewall 44 that extends upwardly from the base 42 to a top portion 46 to form an interior chamber 48, the interior chamber 48 being adapted to contain the liquid 12 (shown in FIG. 2). The interior chamber 48 is best shown in FIGS. 2-3 and discussed further below. In this embodiment, the entire keg container 40 is generally cylindrical, but in other embodiments, any suitable shapes or dimensions of the keg container 40 may be implemented, as the field is continuously developed by those skilled in the art, and this should be considered within the scope of the present invention. When supplying relatively large amounts of liquid 12, in the order of tens of liters, to an establishment it is known to use refillable steel containers, in the case of beer and such, or heavy duty refillable or recyclable plastic containers, in the case of water for water dispensers. However, any suitable materials may be used within the limitations of the claims.

The compressor 20 is operably connected to the keg container 40. In the embodiment of FIGS. 1-2, the compressor 20 is connected to the top portion 46 of the keg container 40 via a coupler 50 mounted thereupon. In some embodiments, the coupler 50 is mounted (e.g., threadedly engaged) with the top portion 46 of the keg container 40, but any form of mounting may be used.

As shown in FIGS. 1-2, the compressor 20 is connected with the keg so that air from the compressor pressurizes the keg container. In this embodiment, the compressor 20 is connected to the coupler 50. In this embodiment, the compressor is connected with a pneumatic hose 28 at port 29, and the hose 28 is connected with the inlet port 52 at the other end, so that air pumped from the air compressor device 20 flows into the keg container 40. As shown in FIG. 2, the air inlet port 52 receives air from the compressor, and is in fluid communication with an air outlet 54 via conduit 68, to direct air from the compressor into the keg container.

The keg system 10 further includes a means for dispensing the liquid 60 from the keg container 40. In this embodiment, the means for dispensing 60 includes a dip tube 62, shown in FIG. 2, that extends to a liquid outlet 64, which may be connected to a tap 68 for dispensing the liquid 12. The dip tube 64 is positioned within the interior chamber 48 of the keg container 40, extending downwardly from the coupler 50 to adjacent the base 42. The dip tube 64 includes a bottom opening 69 for receiving the liquid 12.

In this embodiment, the liquid outlet 64 is connected with a tube 66 which is connected to the tap 68; however, any arrangement desired for dispensing the liquid may be used.

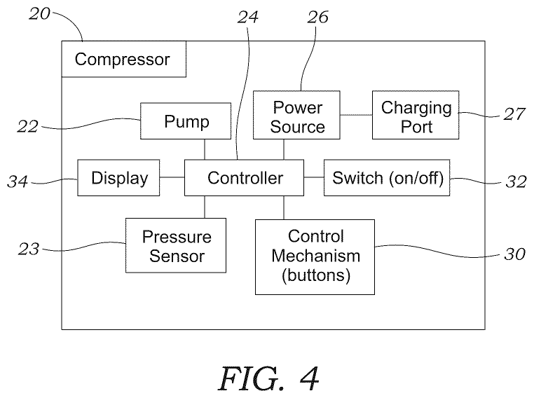

FIG. 4 is block diagram of the air compressor device 20 of the keg system 10. As shown in FIG. 4, in this embodiment, the air compressor device 20 includes the controller 24 that is connected to the pressure sensor 23, the control mechanism 30 (buttons), the pump 22, the display 34, the power source 26, the switch 32, and also to a charging port 27. In one embodiment, the power source 26 is in the form of a rechargeable battery that may be charged using a charging point, i.e., for USB-C, or any other form of charging port known in the art, USB or otherwise. The rechargeable batteries 26 may also or instead be charged via other means, e.g., a wireless charging coil, solar charging, or any other form of recharging a battery. In other embodiments, a DC wall adapted plug may be used instead, or non-rechargeable batteries may be used.

In various embodiments, the air compressor device 20 comprises a pump 22 (internal components shown in FIG. 4) operably controlled by a controller 24 powered by a power source 26. The pump 22 functions to pump air from an air intake 25 into the keg container 40. In this embodiment, the compressor has a port 29 that is connected with a pneumatic hose 28, which may be connected to a coupler 50 via an air inlet port 52.

The air compressor device 20 further includes a pressure sensor 23 operably connected with the controller 24 so that the pump 22 is automatically stopped once the sensed pressure reaches the predetermined selected pressure. The internal components of the air compressor device 20 are best shown in FIG. 4 and discussed further below.

In use, in this embodiment, the interior chamber 48 of the keg container 40 is filled with liquid 12, and the air compressor device 20 is operably connected with the keg container 40. The user then may use the controls to set max and minimum pressures, as discussed above, and then actuate the switch 32 to power on the air compressor device 20 and start pressurizing the keg container. The user may select the desired pressure using the plus and minus buttons 30, wherein the psi is displayed on the display 34. In one embodiment, the selected pressure may be up to 40 psi, with most selections being between 7-15 psi, though usually not exceeding 12 psi.

Many factors may be taken into account when setting min/max pressures, and the pressures should be selected by one skilled in the art to achieve the optimum results. For example, pressure requirements should be selected to provide a suitably fast pour, while achieving the correct amount of foam (“head”). Various conditions may play a role and may require adjusting the pressure. Some factors to consider include ambient temperature, liquid temperature, altitude, the condition of the liquid, and other factors.

Once the pressure is selected, the user may press the switch 32 to begin airflow, or airflow may begin automatically. Alternatively, another button/switch may be included, to start the flow of air. Air is then pumped into the keg container 40 until the pressure sensor 23 indicates that the selected max pressure has been reached, and then the air compressor device 20 stops. The tap 68 (or equivalent) may be actuated to dispense the liquid 12 from the keg container 40. Pressure from the pump 22 may resume once the pressure has dropped below the minimum, to maintain optimum pressure.

FIG. 3 is sectional view of a second embodiment of a keg container 40, wherein the liquid 12 is stored in a flexible bladder 70, instead of the liquid 12 being held only by the interior chamber 48. In this embodiment, the bladder 70 is in fluid communication with liquid outlet 64, while the air outlet 54 of the coupler 50 is outside of the bladder 70. In use, the pressurized air compresses the bladder 70 to cause the liquid 12 to flow out of the liquid outlet 60. This may be particularly useful in an instance where the user wishes to dispense liquid 12 without adding air to the liquid 12, which may cause the liquid to spoil more quickly.

The title of the present application, and the claims presented, do not limit what may be claimed in the future, based upon and supported by the present application. Furthermore, any features shown in any of the drawings may be combined with any features from any other drawings to form an invention which may be claimed.

As used in this application, the words “a,” “an,” and “one” are defined to include one or more of the referenced item unless specifically stated otherwise. The terms “approximately” and “about” are defined to mean+/−10%, unless otherwise stated. Also, the terms “have,” “include,” “contain,” and similar terms are defined to mean “comprising” unless specifically stated otherwise. Furthermore, the terminology used in the specification provided above is hereby defined to include similar and/or equivalent terms, and/or alternative embodiments that would be considered obvious to one skilled in the art given the teachings of the present patent application. While the invention has been described with reference to at least one particular embodiment, it is to be clearly understood that the invention is not limited to these embodiments, but rather the scope of the invention is defined by claims made to the invention.

What is claimed is:

1. A keg system for dispensing a liquid, the keg system comprising:
an air compressor device comprising a pump operably controlled by a controller powered by a power source, the pump functioning to pump air from an air intake to a port that is connected with a pneumatic hose;
the air compressor device further comprising a pressure sensor operably connected with the controller so that the pump is automatically stopped once a sensed pressure reaches a predetermined maximum pressure;
a keg container having a base and an upwardly extending sidewall that extends upwardly from the base to a top portion to form an interior chamber, the interior chamber being adapted to contain the liquid;
a coupler mounted the top portion of the keg container;
an air inlet port of the coupler that is in fluid communication with an air outlet, so that when the pneumatic hose is connected with the inlet port, air pumped from the air compressor device flows into the keg container for pressurizing the interior chamber of the keg container; and
a means for dispensing the liquid from the keg container.

2. The keg system of claim 1, wherein the means for dispensing the liquid from the keg container comprises:
a dip tube within the interior chamber of the container, the dip tube extending downwardly from the coupler to adjacent the base; and
a tap operably connected with the dip tube.

3. The keg system of claim 1, wherein the air compressor device further comprises a control mechanism for selecting the pressure of the compressed air.

4. The keg system of claim 2, wherein the control mechanism includes a display for displaying the selected pressure.

5. The keg system of claim 1, wherein the air compressor device has a rechargeable battery.

6. The keg system of claim 1, further comprising a liquid tube that extends from a liquid outlet to a tap for dispensing pumped liquid.

7. The keg system of claim 1, wherein the maximum pressure is between 4-15 psi.

8. The keg system of claim 1, wherein the compressor is selected to only be able to achieve a maximum pressure of less than 40 psi.

9. A system for dispensing a liquid from a keg, the system comprising:
an air compressor device comprising a pump operably controlled by a controller powered by a power source, the pump functioning to pump air from an air intake into the keg container;
the air compressor device further comprising a pressure sensor operably connected with the controller; and
wherein the controller performs the following steps:
receiving a max pressure and a minimum pressure;
pumping air from the air compressor into the keg until the max pressure is reached, at which time pumping is stopped; and
determining when the pressure drops below the minimum pressure, at which point the pumping is then resumed until the max pressure is again reached.

10. The system of claim 1, wherein the maximum pressure is between 5-15 psi.

11. The system of claim 1, wherein the compressor is selected to only be able to achieve a maximum pressure of less than 40 psi.

12. A method for dispensing a liquid, the method comprising the steps of:
providing a keg container;
providing an air compressor device comprising a pump;
providing a pressure sensor for sensing pressure being applied by the compressor to the liquid;
filling the keg container with the liquid;
operably connecting he air compressor device with the keg container;
pumping air into the keg container until the pressure sensor indicates that a selected pressure has been reached, and then stopping the air compressor device once the selected pressure has been reached; and
dispensing the liquid from the keg container.
